(19) United States
(12) Patent Application Publication
(10) Pub. No.: US 2012/0063394 A1
(43) Pub. Date: Mar. 15, 2012

(54) ACCESS POINT, COMMUNICATION CONTROL METHOD AND RECORDING MEDIUM

(75) Inventor: Yoshimitsu SHIOTANI, Kanagawa (JP)

(73) Assignee: RICOH COMPANY, LTD., Tokyo (JP)

(21) Appl. No.: 13/228,568

(22) Filed: Sep. 9, 2011

(30) Foreign Application Priority Data
Sep. 15, 2010 (JP) 2010-206522

(51) Int. Cl. H04W 72/04; H04W 84/02

(52) U.S. Cl. 370/329

(57) ABSTRACT

An access point for assigning a radio resource to a radio communication apparatus based on admission control, the access point including: a state determination unit configured to determine whether there is a first radio communication apparatus that is in a sleep state by a power saving function; and an assignment unit configured to temporarily assign a radio resource assigned to the first radio communication apparatus to a second radio communication apparatus when the state determination unit determines that there is the first radio communication apparatus.

### CROSS-REFERENCE TO RELATED APPLICATIONS

This application claims the benefit of a Japanese Patent Application No. 2010-206522 filed on Sep. 15, 2010, in the Japanese Patent Office, the disclosure of which is hereby incorporated by reference.

### BACKGROUND OF THE INVENTION

1. Field of the Invention

The present invention relates to a wireless LAN (Local Area Network).

2. Description of the Related Art

The wireless LAN can remove wiring from a conventional wired LAN. Also, according to the wireless LAN, communication can be performed without limitation of places to some extent. Because of these advantages, wireless LAN techniques are attracting attention more and more.

In recent years, the communication speed of the wireless LAN is increasing, and the purpose of use is largely widening. For example, demands for multimedia communications are increasing, that is, demands for realtime traffic such as voice and video streams are increasing. The multimedia communication is sensitive to delay and data loss in data transmission and loss. Thus, a QoS (Quality of Service) control function is essential.

In the standard of IEEE (The Institute of Electrical and Electronics Engineers) 802.11e, realization of the QoS control function is defined. In the IEEE802.11e standard, EDCA (Enhanced Distribution Channel Access) and HCCA(HCF Control Channel Access) are newly defined as access control schemes. In the IEEE802.11e standard, communication traffic is classified into four types of access categories. A priority is given to each access category, and a priority order for transmitting the types of communication traffic is determined based on the priority.

In addition, until the IEEE802.11e standard is formally issued, a simple QoS control function is defined in the WMM (Wi-Fi MultiMedia) standard by Wi-Fi Alliance in which the access control scheme is limited to EDCA. Also in this standard, the communication traffic is classified into four types of access categories. A priority is given to each access category so that priority control for communication traffic is realized.

In the EDCA access control scheme, a wait time until start of data transmission is set for each access category. By setting a short wait time for traffic of a high priority, the traffic of the high priority can be transmitted before transmitting traffic of a low priority. In addition, by setting the wait time for each access category, data such as voice and video can be transmitted in priority to other data.

However, under circumstances in which the number of radio nodes increases in the network, and multiple pieces of voice and video data are transmitted and received simultaneously, there is a high possibility that a collision of packets occurs. So, there is a problem in that effects obtained by QoS control diminish.

In the HCCA access control scheme, an AP (Access Point) assigns a transmission time according to types of data. A scheduler implemented in the AP compares communication requests of STAs (radio nodes that do not have an access point function) so as to determine a transmission time and transmission timing of each radio node, and reports them to each radio node. According to this scheme, a communication band is assured with certainty. However, control for the network is likely to become complicated, and the performance deteriorates compared to the EDCA control scheme.

In order to solve the problems of the above-mentioned two access control schemes to some extent, an admission control function is defined in both of IEEE802.11e and WMM.

According to the admission control function, in a radio network between an AP and radio nodes, when an STA desires to perform communication by using a particular access category determined by the AP, the STA transmits an ADDTS (Add Traffic Stream) request management frame to the AP.

The AP compares a radio resource amount requested by the STA with use status of radio resources that are currently being used, and sends a response for the request. An STA that is allowed to transmit data by the AP can perform data transmission during a given time using the access category. On the other hand, an STA rejected by the AP cannot perform data transmission using the access category. Also, when data transmission is not performed in the access category or when the AP causes the STA to stop data transmission using the access category, the AP transmits a DELTS (Delete Traffic Stream) management frame in order to cause the STA to stop communication using the access category.

In the admission control function, an algorithm by which the AP performs scheduling of the use amount of radio resources is not defined in either of the standards, and the algorithm depends on implementation.

Also, in recent years, demands are increasing more and more for using a radio device by embedding it in a product for mobile use. For embedding a radio device in a product for mobile use, power saving of the radio device is an important issue. In general, power saving is realized by stopping operation of the radio device when the radio device does not perform communication, and it is important to decrease operation time as much as possible.

Thus, it is desired for radio devices to transfer realtime traffic such as voice and video data without delay and loss, and at the same time, power saving is desired.

As to the radio network using the admission control, a method for assigning radio resources is proposed (Japanese Laid-Open Patent Applications No. 2009-177839, No. 2010-517353 and No. 2006-528861, for example). In the method, when a radio communication apparatus sends a request for a radio resource, the radio communication apparatus sends, together with the request, a standard parameter set such as average data rate, burst size, average data size and the like, so that a radio resource is assigned based on the parameter set and use status of current radio resources. By assigning radio resources to the radio communication apparatus based on the parameter set and use status of current radio resources, a radio resource can be assigned efficiently. In addition, a radio resource necessary for realtime transfer can be assigned with reliability.

However, according to the technique, even when the radio communication apparatus enters a sleep state according to a power saving function, the radio resource continues to be assigned. Thus, radio resources that other radio communication apparatuses can use are limited.

### SUMMARY OF THE INVENTION

Accordingly, it is an object in one embodiment of the present invention to improve use efficiency of radio resources.

According to one aspect of the present invention, there is provided an access point for assigning a radio resource to a radio communication apparatus based on admission control, the access point including:
a state determination unit configured to determine whether there is a first radio communication apparatus that is in a sleep state by a power saving function; and
an assignment unit configured to temporarily assign a radio resource assigned to the first radio communication apparatus to a second radio communication apparatus when the state determination unit determines that there is the first radio communication apparatus.

According to another aspect of the present invention, there is provided a communication control method in an access point for assigning a radio resource to a radio communication apparatus based on admission control, the communication control method including the steps of:
determining whether there is a first radio communication apparatus that is in a sleep state by a power saving function; and
temporarily assigning a radio resource assigned to the first radio communication apparatus to a second radio communication apparatus when it is determined that there is the first radio communication apparatus.

According to still another aspect of the present invention, there is provided a non-transitory computer-readable recording medium storing a program for causing a computer functioning as an access point to execute the steps of:
determining whether there is a first radio communication apparatus that is in a sleep state by a power saving function; and
temporarily assigning a radio resource assigned to the first radio communication apparatus to a second radio communication apparatus when it is determined that there is the first radio communication apparatus.

Other objects and further features of the present invention will be apparent from the following detailed description when read in conjunction with the accompanying drawings.

### BRIEF DESCRIPTION OF THE DRAWINGS

FIG. 1 is a diagram showing an example of a radio network according to an embodiment of the present invention;

FIGS. 2A-2C are functional block diagrams showing examples of an access point according to an embodiment of the present invention;

FIG. 3 is a functional block diagrams showing an example of a scheduler according to an embodiment of the present invention;

FIG. 4 is a time chart showing an example of operation of the radio network according to an embodiment of the present invention;

FIG. 5 is a diagram showing an example of access categories according to an embodiment of the present invention;

FIG. 6 is a flowchart showing an example of operation of the radio network according to an embodiment of the present invention; and

FIG. 7 is a flowchart showing an example of operation of the radio network according to an embodiment of the present invention.

### DESCRIPTION OF THE PREFERRED EMBODIMENTS

Prior to describing an embodiment of the present invention, a problem will be described for convenience of understanding.

In the admission control function defined in the IEEE802.11e standard or the WMM standard, even when a radio communication apparatus that is assigned a radio resource of a particular category enters a sleep state according to a power saving function, assignment of the radio resource for the radio communication apparatus continues.

In a state where there is not enough available radio resource for the particular access category, if another radio communication apparatus sends a use request for communication of the particular access category, the use request is rejected. The reason is that, the assignment of the radio resource for the radio communication apparatus continues even though the radio communication apparatus enters a sleep state and the radio resource is not used in the sleep state.

In the following, an embodiment for carrying out the present invention for solving the problem is described with reference to drawings. Throughout the drawings illustrating the embodiment, the same reference symbols are attached to those having the same functions, and descriptions thereof are not repeated.

<Radio Network>

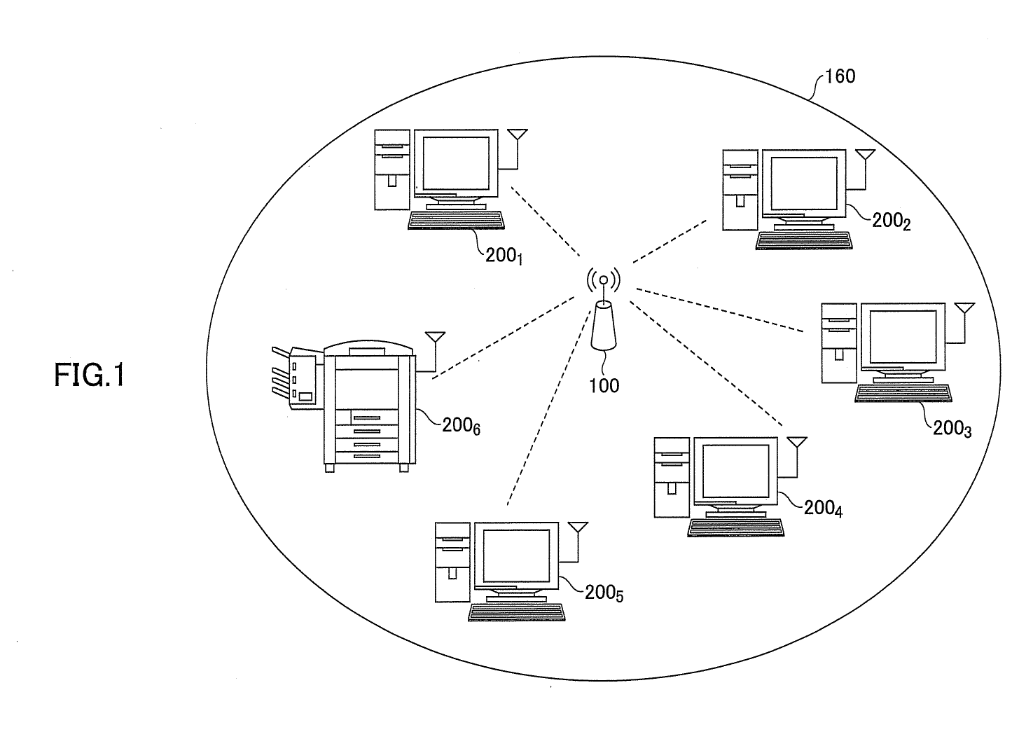

FIG. 1 shows an example of a radio network according to the present embodiment.

The radio network preferably includes a wireless LAN, but it may include networks other than the wireless LAN. The radio network may be applied to a distributed control network in which EDCA (Enhanced Distributed Channel Access) is applied for performing priority control based on autonomous-distributed control. Also, the radio network may be applied to a centralized control network in which HCCA (Hybrid Coordination Function Controlled Channel Access) is applied for ensuring quality by performing centralized control using polling by an access point.

The radio network includes an access point (AP) 100 and radio communication apparatuses (each of which can be also referred to as STA: Station) 200ₙ (n is an integer of n>0). FIG. 1 shows, as an example, one access point 100, and 6 radio communication apparatuses 200₁-200₆. The radio communication apparatuses 200₁-200₆ exist in an area (wireless LAN network area) 160 covered by the access point 100.

The access point 100 includes a scheduling function. By the scheduling function, admission control is performed.

The radio communication apparatus 200ₙ performs data communication according to scheduling performed by the access point 100. Also, the radio communication apparatus 200ₙ includes a power saving function. For example, the power saving function may be a function defined in the wireless LAN standard (IEEE802.11). The radio communication apparatus 200ₙ including the power saving function has at least two states that are a normal operation state (also referred to as active state) and a sleep state.

As long as the radio communication apparatuses 200ₙ are included in the radio network, a part of the radio network may be configured by a cable network.

In the present embodiment, as an example, a case is described in which the radio communication apparatuses 200ₙ perform radio communication according to the specification of the IEEE802.11 standard. But, the radio communication apparatuses 200ₙ may perform radio communication according to another standard of radio communication. Also, each of the radio communication apparatuses 200 implements a QoS (Quality Of Service) control function. The QoS control function may be one defined in the IEEE802.11e standard.

<Access Point>

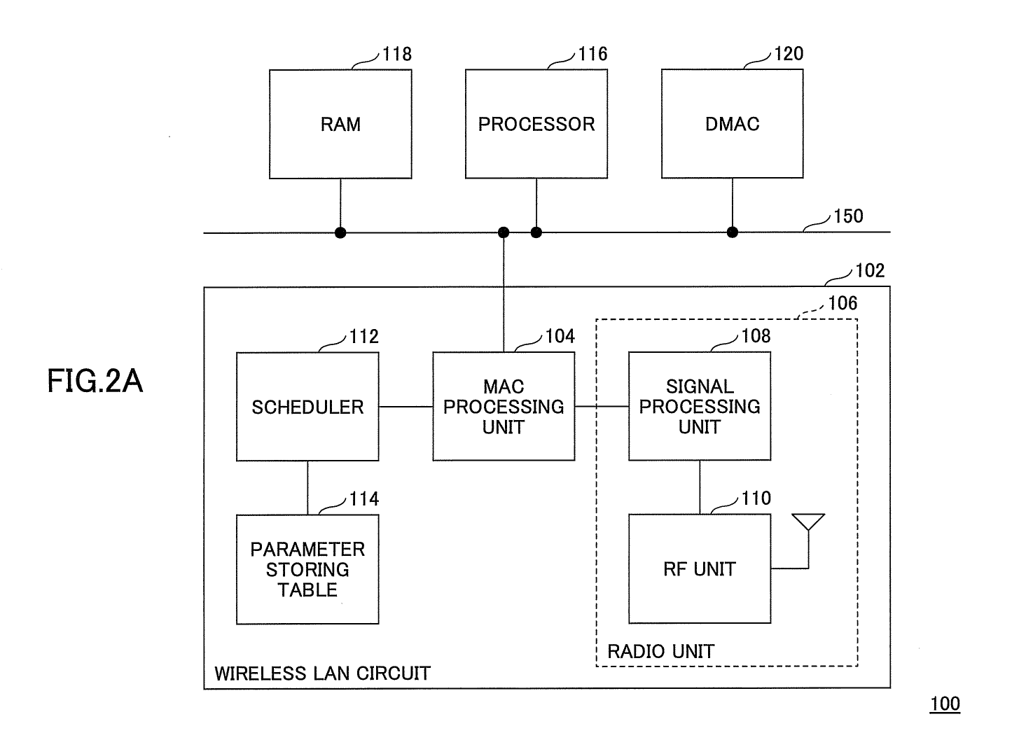

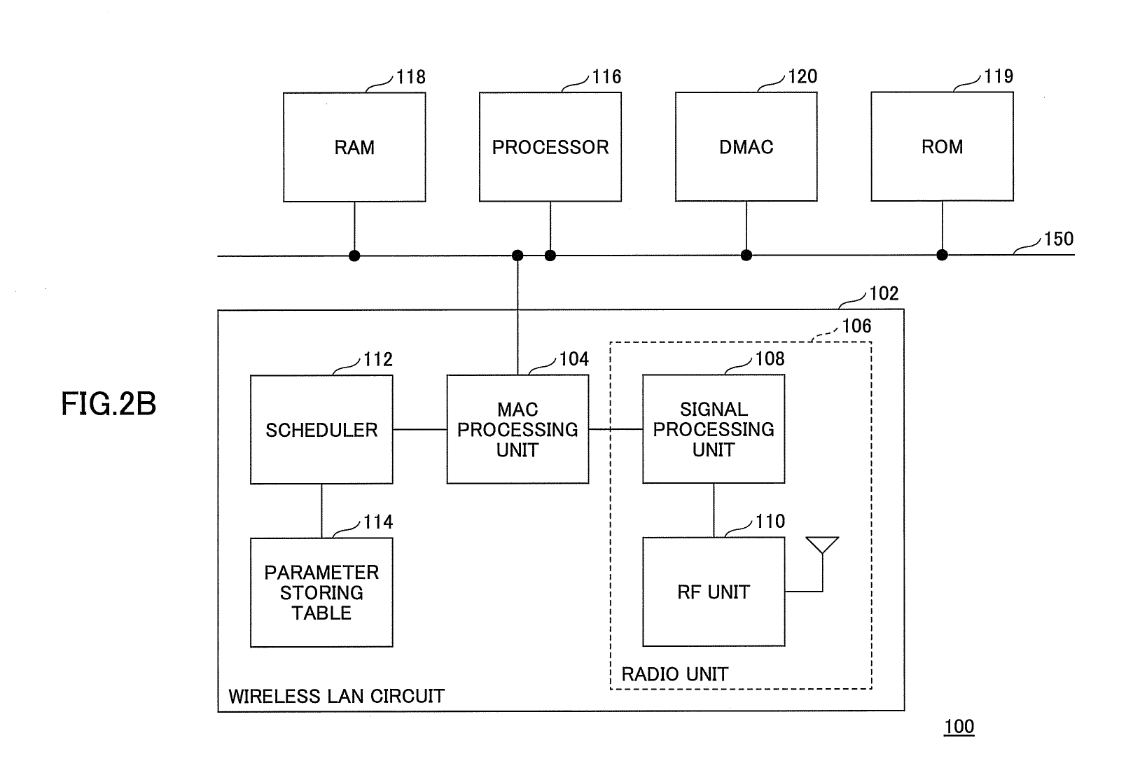

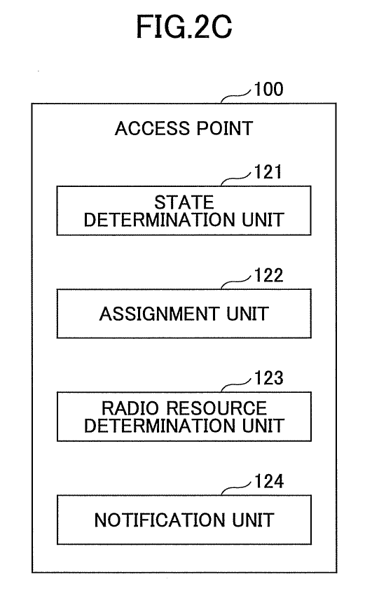

FIG. 2A is a functional block diagram showing the access point 100 according to the present embodiment.

The access point 100 includes a wireless LAN circuit 102. The wireless LAN circuit 102 controls the access point according to the radio communication standard.

The wireless LAN circuit 102 includes a MAC (Medium Access Control) processing unit 104. The MAC processing unit 104 realizes a function of the MAC sublayer in the OSI (Open Systems Interconnection) reference model.

The wireless LAN circuit 102 includes a radio unit 106. The radio unit 106 is connected to the MAC processing unit 104. The radio unit 106 realizes a function of the physical layer in the OSI reference model.

The radio unit 106 includes a signal processing unit 108 and an RF (Radio Frequency) unit 110. The signal processing unit 108 is connected to the MAC processing unit 104, and the RF unit 110 is connected to the signal processing unit 108.

The wireless LAN circuit includes a scheduler 112. The scheduler 112 is connected to the MAC processing unit 104. The scheduler realizes an admission control function. The function executed by the scheduler 112 may be realized by hardware or may be realized by a processor 116 according to software.

The wireless LAN circuit 102 includes a parameter storing table 114. The parameter storing table 114 is connected to the scheduler 112. The parameter storing table 114 stores communication parameters and assigned times and the like for the radio communication apparatuses 200ₙ in the radio network.

The access point 100 includes a processor 116. The processor 116 performs processing for a part of radio communication functions by software. Also, the access point 100 includes a RAM 118.

The access point 100 includes a DMAC (Direct Memory Access controller) 120. The DMAC 120 performs data transfer between the wireless LAN circuit 102 and the RAM 118 without processing of the processor 116.

A bus 150 connects the MAC processing unit 104, the processor 116, the RAM 118 and the DMAC 120.

Also, as an example, the access point 100 may be configured such that a ROM such as a flash ROM can be connected. FIG. 2B shows an example of the access point 100 to which a ROM 119 such as the flash ROM is connected. The ROM 119 stores a program corresponding to processing of the scheduler 112, and the processor 116 reads and executes the program to perform the processing. The ROM 119 is an example of an after-mentioned computer-readable recording medium in which a program is stored.

FIG. 2C shows another example of a functional block diagram of the access point 100. Functions of units shown in FIG. 2C are mainly realized by the scheduler 112. As shown in FIG. 2C, the access point 100 includes a state determination unit 121, an assignment unit 122, a radio resource determination unit 123, and a notification unit 124. Although FIG. 2C shows an example including the units 121-124, the access point 100 is not limited to that configuration shown in FIG. 2C. An example of operation of each unit is described below.

The state determination unit 121 determines whether there is a first radio communication apparatus that is in a sleep state by a power saving function. The assignment unit 122 temporarily assigns a radio resource assigned to the first radio communication apparatus to a second radio communication apparatus when the state determination unit determines that there is the first radio communication apparatus. Also, when the first radio communication apparatus returns to a normal operation state, the assignment unit 122 reassigns the radio resource, to the first radio communication apparatus, that is temporarily assigned to the second radio communication apparatus.

The radio resource determination unit 123 determines whether there is enough radio resource to be assigned to the second radio communication apparatus after the radio resource temporarily assigned to the second radio communication apparatus is reassigned to the first radio communication apparatus. Also, the notification unit 124 notifies the second radio communication apparatus to stop use of the radio resource when the radio resource determination unit determines that there is not enough radio resource to be assigned to the second radio communication apparatus.

<Wireless LAN Circuit>

In the following, the wireless LAN circuit 102 is described in detail.

The signal processing unit 108 modulates transmission data supplied from the MAC processing unit 104 to convert the data to analog data, and supply the analog data to the RF unit 110. The RF unit 110 converts the analog data supplied from the signal processing unit 108 to a radio signal, and transmits the radio signal using radio wave.

Also, the RF unit 110 converts received radio wave into analog data, and supplies the analog data to the signal processing unit 108. The signal processing unit 108 converts the analog data supplied from the RF unit 110 to digital data, and demodulates the digital data to supply necessary data to the MAC processing unit 104.

The MAC processing unit 104 processes transmission data into a radio packet, and supplies the radio packet to the signal processing unit 108. The MAC processing unit 104 extracts data supplied from the signal processing unit 108. Also, the MAC processing unit 104 performs encryption/decryption as necessary for packets. In addition, the MAC processing unit 104 determines a time when a packet can be transmitted, and sends a transmission instruction to the radio unit 106 according to the determination.

The scheduler 112 realizes the admission control function. The scheduler 112 calculates a radio resource to be assigned to each radio communication apparatus 200ₙ for each access category according to the parameters stored in the parameter storing table 114. The radio resource may be represented by a data transmission available time. Also, the parameters to be stored in the parameter storing table 114 may be extracted from a TSPEC (Traffic Specification) value received from each radio communication apparatus 200ₙ.

According to a data transmission time requested by the radio communication apparatus 200ₙ, when there is enough available (idle) radio resource in current radio resources, the scheduler 112 notifies the MAC processing unit 104 of existence of an available radio resource and an assigned time. On the other hand, According to the data transmission time requested by the radio communication apparatus 200ₙ, when there is not enough available radio resource in current radio resources, the scheduler 112 notifies the MAC processing unit 104 of rejection of the request.

The parameter storing table 1134 stores parameters extracted from the TSPEC (Traffic Specification) values received from each radio communication apparatus 200ₙ.

<Scheduler>

In the following, functions of the scheduler 112 are described in detail.

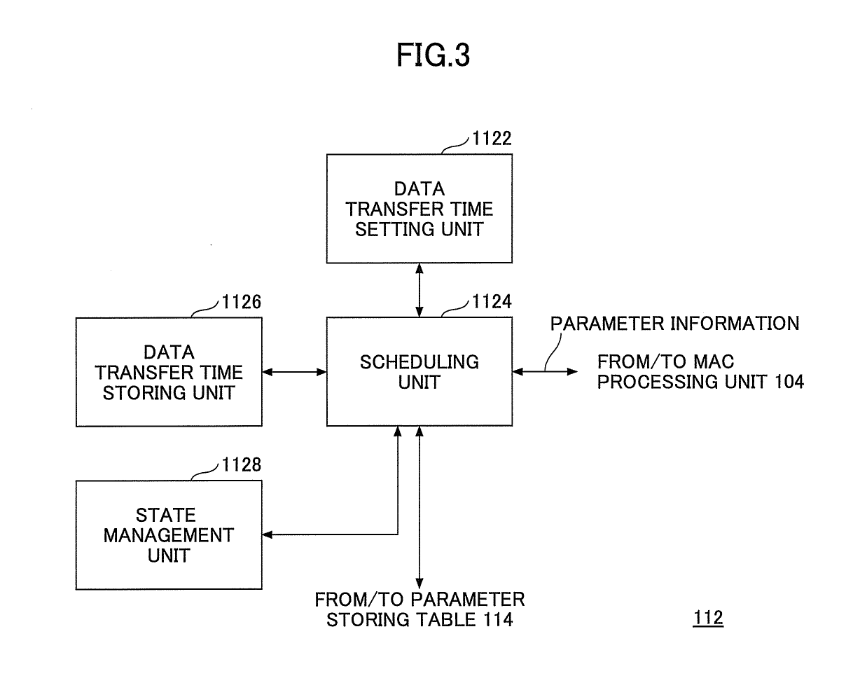

FIG. 3 shows a functional block diagram showing the scheduler 112.

The scheduler 112 includes a data transfer time setting unit 1122. In accordance with the IEEE802.11e standard in the present embodiment, communication traffic is classified into four types of access categories. Priority order for transmission is determined for each access category. The data transfer time setting unit 1122 sets a time in which a radio communication apparatus can transfer data of access categories corresponding to voice and video, for example. For example, the data transfer time setting unit 1122 may set a time for transmitting data to be a predetermined fixed value. Also, the data transfer time setting unit 1122 may set a time for transmitting data to be a value set by a user. The data transfer time setting unit 1122 supplies information indicating the data transfer time that is set to the scheduling unit 1124.

In the following, an access category of voice is represented by “AC_VO”, and an access category of video is represented by AC_VI. Also, a total time in which data belonging to AC_VO can be transferred is represented by “TOTAL_TIME(AC_VO)” (also may be represented by “TIME(AC_VO)”), and a total time in which data belonging to AC_VI can be transferred is represented by “TOTAL_TIME(AC_VI)” (also may be represented by “TIME(AC_VI)”).

The scheduler 112 includes a scheduling unit 1124. The scheduling unit 1124 is connected to the data transfer time setting unit 1122. Parameter information is supplied to the scheduling unit 1124 from the MAC processing unit 104. The parameter information may include information such as average data rate, maximum data rate, burst size and average packet size. The parameter information may be included in a TSPEC value of a transmission request signal (ADDTS-REQ frame) transmitted by a radio communication apparatus 200ₙ in order to transmit data belonging to AC_VO. In the following, a radio communication apparatus that has sent a transmission request may be represented by “REQ_STA”.

The scheduling unit 1124 calculates a transmission available time (that is also referred to as Admitted Time or Medium Time) to be assigned to the REQ_STA based on the parameter information. The scheduling unit 1124 determines whether there is enough idle time for assigning the transmission available time in TOTAL_TIME(AC_VO) stored in the data transfer time storing unit 1126.

When there is the idle time, the scheduling unit 1124 assigns the transmission available time to the REQ_STA. The scheduling unit 1124 updates the TOTAL_TIME(AC_VO). For example, the scheduling unit 1124 subtracts the transmission available time from the TOTAL_TIME(AC_VO), and sets the TOTAL_TIME(AC_VO) from which the transmission available time has been subtracted to be a new TOTAL_TIME(AC_VO).

When there is not enough idle time, the scheduling unit 1124 refers to the state management unit 1128, and determines whether there is a radio communication apparatus that is assigned a radio resource for transmitting data of AC_VO and that is in a sleep state among radio communication apparatuses other than the REQ_STA belonging to the radio network.

When it is determined that there is the radio communication apparatus, the scheduling unit 1124 determines whether there is enough idle time for assigning the transmission available time in TOTAL_TIME(AC_VO) of the radio communication apparatus of the sleep state in the TOTAL_TIME(AC_VO) stored in the data transfer time storing unit 1126.

When there is the idle time, the scheduling unit 1124 assigns, to the REQ_STA, the transmission available time from a radio resource assigned to the radio communication apparatus in the sleep state. The scheduling unit 1124 updates the TOTAL_TIME(AC_VO) of the radio communication apparatus of the sleep state. For example, the scheduling unit 1124 subtracts the transmission available time from TOTAL_TIME(AC_VO) of the radio communication apparatus of the sleep state, and set the TOTAL_TIME(AC_VO) from which the transmission available time has been subtracted to be a new TOTAL_TIME(AC_VO).

When there is not enough idle time, the scheduling unit 1124 refers to the state management unit 1128, and determines whether there is a radio communication apparatus that is assigned a radio resource for transmitting data of AC_VI and that is in a sleep state among radio communication apparatuses other than the REQ_STA belonging to the radio network.

When it is determined that there is the radio communication apparatus, the scheduling unit 1124 determines whether there is enough idle time for assigning the transmission available time in TOTAL_TIME(AC_VI) of the radio communication apparatus of the sleep state in TOTAL_TIME(AC_VI) stored in the data transfer time storing unit 1126.

When there is the idle time, the scheduling unit 1124 assigns, to the REQ_STA, the transmission available time from a radio resource assigned to the radio communication apparatus in the sleep state. The scheduling unit 1124 updates the TOTAL_TIME(AC_VI) of the radio communication apparatus of the sleep state. For example, the scheduling unit 1124 subtracts the transmission available time from the TOTAL_TIME(AC_VI) of the radio communication apparatus of the sleep state, and set the TOTAL_TIME(AC_VI) from which the transmission available time has been subtracted to be a new TOTAL_TIME(AC_VO).

When there is not the radio communication apparatus of the sleep state, and when there is not enough idle time for assigning the transmission available time, the scheduling unit 1124 supplies to the MAC processing unit 104 information indicating that the transmission available time cannot be assigned. The information indicating that the transmission available time cannot be assigned may be ADDTS-RESP including a status code that indicates an error.

The scheduler 1122 includes the data transfer time storing unit 1126. The data transfer time storing unit 1126 is connected to the scheduling unit 1124. The data transfer time storing unit 1126 stores information of radio resources assigned to radio communication apparatuses 200ₙ for each of the radio communication apparatuses 200ₙ covered by the access point 100.

Information of the radio resources includes the time TOTAL_TIME(AC_VO) in which data belonging to AC_VO can be transmitted and the time TOTAL_TIME(AC_VI) in which data belonging to AC_VI can be transmitted. The scheduler 112 includes the state management unit 1128. The state management unit 1128 is connected to the scheduling unit 1124. The state management unit 1128 stores information indicating states of the radio communication apparatuses 200ₙ for each of the radio communication apparatuses 200ₙ covered by the access point 100. The information indicating the states includes an active state and a sleep state.

<Operation of Radio Network>

In the radio network of the present embodiment, a radio communication apparatus (STA1) 200₁ uses a power saving function according to the IEEE802.11e standard.

In a sleep period of the STA1, another radio communication apparatus (STA2) 200₂ transmits a radio resource use request. For example, the radio communication apparatus 200₂ transmits an ADDTS-REQ frame to request use of a radio resource.

The access point (AP) 100 assigns a radio resource according to the ADDTS-REQ transmitted by the STA2.

The STA2 performs data transmission according to the radio resource assigned by the AP 100.

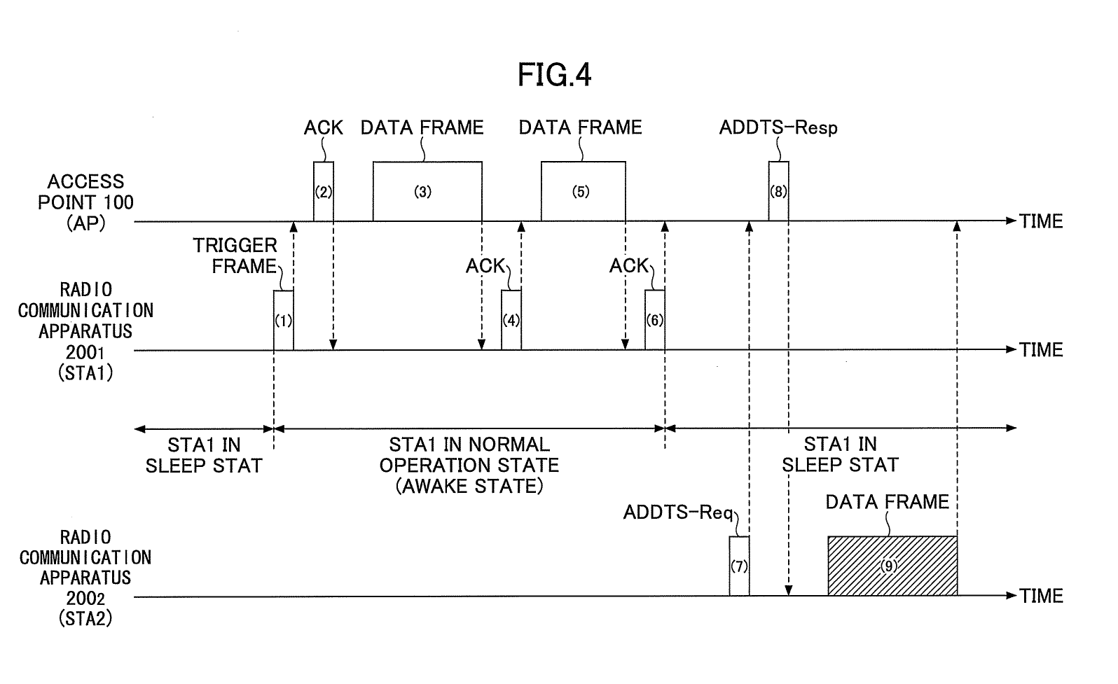

FIG. 4 shows a processing example among the access point 100, the radio communication apparatus 200₁ and the radio communication apparatus 200₂.

In the example shown in FIG. 4, it is assumed that there is not enough idle resource until the STA1 enters a sleep state.

When the STA1 returns from the sleep state, the STA1 transmits a trigger frame to the access point (AP) 100 (1). Using the trigger frame, the STA1 requests the AP 100 to transmit data addressed to the STA1 buffered in the AP 100 while the STA1 is in the sleep state.

The AP 100 that receives the trigger frame transmits an acknowledgement (ACK) (2). The STA1 receives all buffered data from the AP 100 (3)-(6). The STA1 enters the sleep state again.

After the STA1 enters the sleep state, the STA2 transmits to request use of a radio resource (7). When the AP 100 receives the from the STA2, the AP 100 calculates a transmission available time to be assigned to the STA2 based on parameter information. When there is not enough idle time for assigning the transmission available time in the time of TOTAL_TIME(AC_VO) in which data belonging to AC_VO can be transmitted, the AP 100 temporarily assigns, to the STA2, a radio resource (transmission available time) assigned to the STA1. The AP 100 transmits a response (ADDIS-Resp) for the (8).

The STA2 transmits a data frame using the radio resource assigned by the AP 100 (9). The radio resource is also a radio resource assigned to the STA1 that is in the sleep state.

<Admission Control Method>

In the following, an admission control method is described.

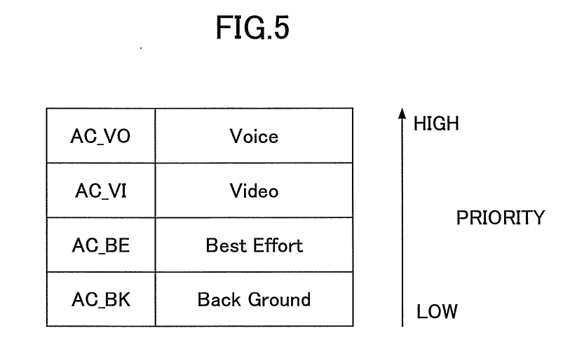

For example, in accordance with the IEEE802.11e standard in the present embodiment, four types of access categories are defined. FIG. 5 shows the four types of access categories.

The four types of access categories include “AC_VO”, “AC_VI”, “AC_BE” and “AC_BK”. AC_VO represents voice, AC_VI represents video, AC_BE represents best effort, and AC_BK represents background.

Data belonging to AC_VO has the highest priority for data transmission. The priority becomes lower in the order of AC_VI, AC_BE and AC_BK.

Also, in the IEEE802.11e standard, it is recommended to use two of the access categories that are AC_VO and AC_VI for use in admission control. The present embodiment follows the recommended condition. But, admission control may be performed for more than two access categories. As an example, in the present embodiment, a case is described in which admission control is not used for data belonging to AC_BE and AC_BK. Therefore, as to the data belonging to AC_BE and AC_BK, since data transmission is performed according to an access control scheme (EDCA or HCCA) that is being used, assignment of data transmission time does not need to be allowed by the AP.

<Calculation Method of Transmission Time>

In the following, a method for calculating a transmission time to be assigned by the AP is described. The calculation method described below is an example, and other calculation methods may be used.

Data transfer times of TOTAL_TIME(AC_VO) and TOTAL_TIME(AC_VI) that can be used by data belonging to AC_VO and AC_VI are determined respectively. Fixed values may be used for the times. Or, a user may freely set the times according to a network environment. The times may be determined according to how long time can be assigned for data transmission belonging to AC_VO, for example. That is, the times of TOTAL_TIME(AC_VO) and TOTAL_TIME(AC_VI) may be determined such that the equation (1) holds true.

TOTAL_TIME(AC_VO)+TOTAL_TIME(AC_VI)=1 (1)

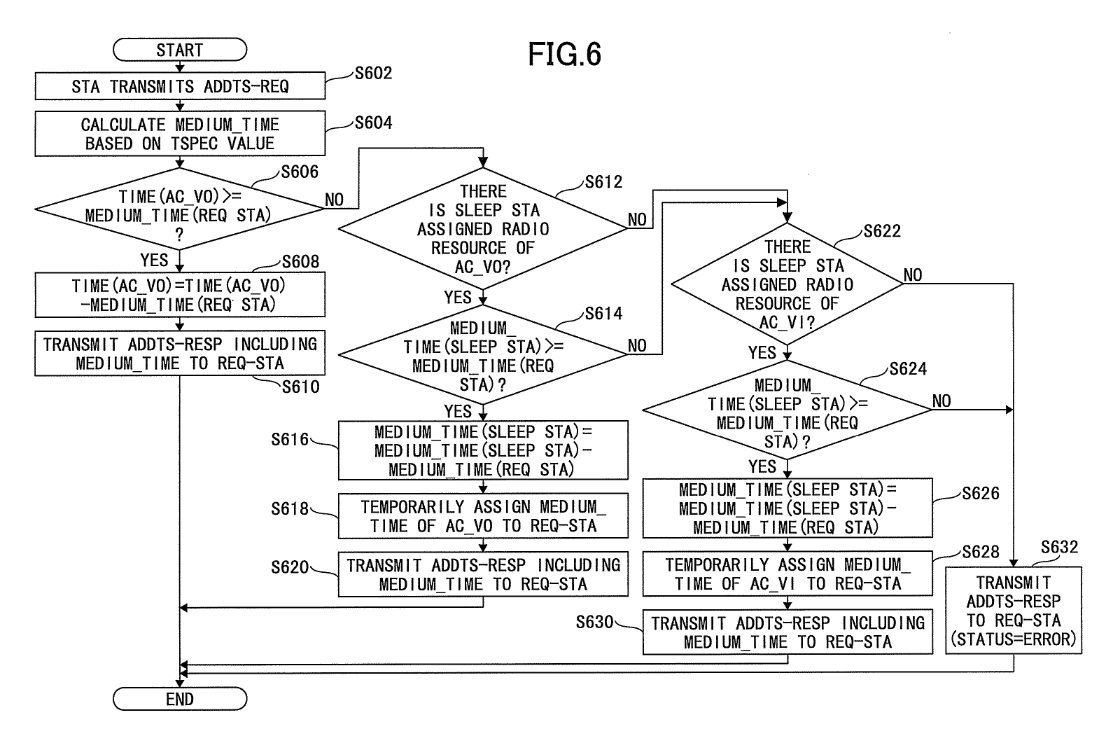

FIG. 6 is a flowchart (1) showing an example of operation of the radio network of the present embodiment.

The access point 100 uses admission control for AC_VO and AC_VI. But, this is merely an example, and admission control may be performed for more than two categories, and also admission control may be performed for one category, that is, for only AC_VO, for example.

In step S602, a radio communication apparatus (REQ_STA) 200ₙ belonging to the radio network transmits an ADDTS-REQ frame including a TSPEC value to the AP in order to request data transmission belonging to AC_VO.

When the AP 100 receives the ADDTS-REQ frame from the radio communication apparatus 200ₙ, the AP 100 calculates a transmission available time (that can be also referred to as Admitted Time or Medium Time) to be assigned to the REQ-STA based on parameter information included in the TSPEC value in step 5604. The parameter information includes average data rate, maximum data rate, burst size and average packet size and the like.

In step S606, the AP 100 determines whether there is enough idle time that can be assigned as the transmission available time calculated in step S604 in the total time for data transmission belonging to AC_VO. For example, the scheduling unit 1124 determines whether there is enough idle time that can be assigned as the transmission available time in the total time for data transmission belonging to AC_VO.

When it is determined that there is the idle time that can be assigned as the transmission available time (Yes in step S606), the AP 100 updates the total time that can be used for data communication belonging to AC_VO according to the following equation (2) in step S608. For example, the scheduling unit 1124 updates the total time that can be used for data communication belonging to AC_VO.

TOTAL_TIME(AC_VO)=TOTAL_TIME(AC_VO)−MEDIUM_TIME(REQ-STA) (2)

The AP 100 transmits an ADDTS-RESP frame including the assigned time information MEDIUM_TIME(REQ-STA) for notification to the REQ-STA in step 5610. For example, the scheduling unit 1124 supplies the assigned time information to the MAC processing unit 104 such that the assigned time information can be transmitted as the ADDTS-RESP frame.

On the other hand, when it is not determined that there is the idle time that can be assigned as the transmission available time (No in step S606), the AP 100 determines whether there is a radio communication apparatus (STA) that is assigned a data transmission time belonging to AC_VO and that is in the sleep state among radio communication apparatuses 200ₙ included in the radio network in step S612. For example, the scheduling unit 1124 refers to the data transfer time storing unit 1126 and the state management unit 1128 in order to determine whether there is a radio communication apparatus (STA) that is assigned a data transmission time belonging to AC_VO and that is in the sleep state among radio communication apparatuses 200ₙ included in the radio network.

When it is determined that there is the radio communication apparatus (Yes in step S612), the AP 100 determines whether the time MEDIUM_TIME(REQ-STA) requested by the REQ-STA falls within the time MEDIUM_TIME(SLEEP_STA) assigned to the radio communication apparatus (STA) of the sleep state in step S614. For example, it is determined whether the equation (3) holds true. For example, the scheduling unit 1124 determines whether the time MEDIUM_TIME(REQ-STA) requested by the REQ-STA falls within the time MEDIUM_TIME(SLEEP_STA) assigned to the radio communication apparatus (STA) that is assigned a data transmission time belonging to AC_VO and that is in the sleep state.

MEDIUM_TIME(REQ-STA)≦MEDIUM_TIME(SLEEP_STA) (3)

When it is determined that the time MEDIUM_TIME(REQ-STA) requested by the REQ-STA falls within the time MEDIUM_TIME(SLEEP_STA) assigned to the radio communication apparatus (STA) of sleep state (Yes in step S614), the AP 100 updates a total time that can be assigned temporarily according to the equation (4). For example, the scheduling unit 1124 updates the total time MEDIUM_TIME(SLEEP_STA) assigned to the radio communication apparatus (STA) that is assigned a data transmission time belonging to AC_VO and that is in the sleep state.

MEDIUM_TIME(SLEEP_STA)=MEDIUM_TIME(SLEEP_STA)−MEDIUM_TIME(REQ-STA) (4)

The AP 100 temporarily assigns a time of the MEDIUM_TIME(SLEEP_STA) to the REQ-STA in step S618. For example, the scheduling unit 1124 temporarily assigns a time of MEDIUM_TIME(SLEEP_STA) to the REQ-STA.

In step S620, the AP 100 transmits an ADDTS-RESP frame including the assigned time information (MEDIUM_TIME(REQ-STA)) that is temporarily assigned in step S618 to the REQ-STA for notification. For example, the scheduling unit 1124 supplies the temporarily-assigned time information to the MAC processing unit 104 such that the temporarily-assigned time information can be transmitted as the ADDTS-RESP frame.

When it is not determined that there is the radio communication apparatus (STA) of the sleep state in step S612 (No in step S612), and when it is not determined that the time MEDIUM_TIME(REQ-STA) requested by the REQ-STA falls within the time MEDIUM_TIME(SLEEP_STA) assigned to the radio communication apparatus (STA) of the sleep state in step S614 (No in step S614), the AP 100 determines whether there is a radio communication apparatus (STA) that is assigned a radio resource for AC_VI having lower priority than AC_VO and that is in the sleep state in step S622. For example, the scheduling unit 1124 refers to the data transfer time storing unit 1126 and the state management unit 1128 in order to determine whether there is a radio communication apparatus (STA) that is assigned a data transmission time belonging to AC_VI and that is in the sleep state.

When it is determined that there is the radio communication apparatus (STA) in step S622 (Yes in step S622), the AP 100 determines whether the time MEDIUM_TIME(REQ-STA) requested by the REQ-STA falls within the time MEDIUM_TIME(SLEEP STA) assigned to the radio communication apparatus (STA) of the sleep state in step S624. For example, it is determined whether the equation (3) holds true. For example, the scheduling unit 1124 determines whether the time MEDIUM_TIME(REQ-STA) requested by the REQ-STA falls within the time MEDIUM_TIME(SLEEP_STA) assigned to the radio communication apparatus (STA) that is assigned a data transmission time belonging to AC_VI and that is in the sleep state.

When it is determined that the time MEDIUM_TIME(REQ-STA) requested by the REQ-STA falls within the time MEDIUM_TIME(SLEEP_STA) assigned to the radio communication apparatus (STA) of the sleep state (Yes in step S624), the AP 100 updates a total time that can be temporarily assigned according to the equation (4). For example, the scheduling unit 1124 updates the time MEDIUM_TIME(SLEEP_STA) assigned to the radio communication apparatus (STA) that is assigned a data transmission time belonging to AC_VI and that is in the sleep state.

The AP 100 temporarily assigns a time of MEDIUM_TIME(SLEEP_STA) to the REQ-STA in step 5628. For example, the scheduling unit 1124 temporarily assigns the time of MEDIUM_TIME(SLEEP_STA) to the REQ-STA.

In step S630, the AP 100 transmits an ADDTS-RESP frame including the assigned time information that is temporarily assigned in step S628 to the REQ-STA for notification. For example, the scheduling unit 1124 supplies the temporarily-assigned time information to the MAC processing unit 104 such that the temporarily-assigned time information can be transmitted as the ADDTS-RESP frame.

When it is not determined that there is the radio communication apparatus (STA) of the sleep state in step S622 (No in step S622), and when it is not determined that the time MEDIUM_TIME(REQ-STA) requested by the REQ-STA falls within the time MEDIUM_TIME(SLEEP_STA) assigned to the radio communication apparatus (STA) of the sleep state in step S624 (No in step S624), a radio resource can not be assigned to the STA that requests the radio resource. Therefore, the AP 100 transmits an ADDTS-RESP frame including STATUS CODE that indicates an error to the REQ-STA for notification in step S632. For example, the scheduling unit 1124 supplies information indicating an error as STATUS CODE to the MAC processing unit 104 such that the error can be transmitted by the ADDTS-RESP frame.

The processing of steps S604-S632 is executed by the processor 116 according to the function of the scheduler 112. A program for causing the processor 116 to function as the scheduler 112 can be stored in a non-transitory recording medium such as a flexible disk, a CD-ROM and a memory card, a flash ROM, and the like, and the non-transitory recording medium in which the program is stored can be provided. Also, the program can be downloaded via a communication network. For example, by inserting the recording medium into an auxiliary storage device of a computer, the program recorded in the recording medium is read. The access point 100 is an example of the computer. The processor 116 writes the read program in the RAM 118 or an HDD, and executes the program to perform the processing. The program causes the computer to execute each step of S604-S632 shown in FIG. 6. Also, for example, the program may be configured to cause the computer to execute at least a part of the steps of S604-S632.

Next, a case is described in which the radio communication apparatus (STAT) 200₁ that has been assigned a data transmission time for AC_VO and that has been in the sleep state returns to a normal operation state.

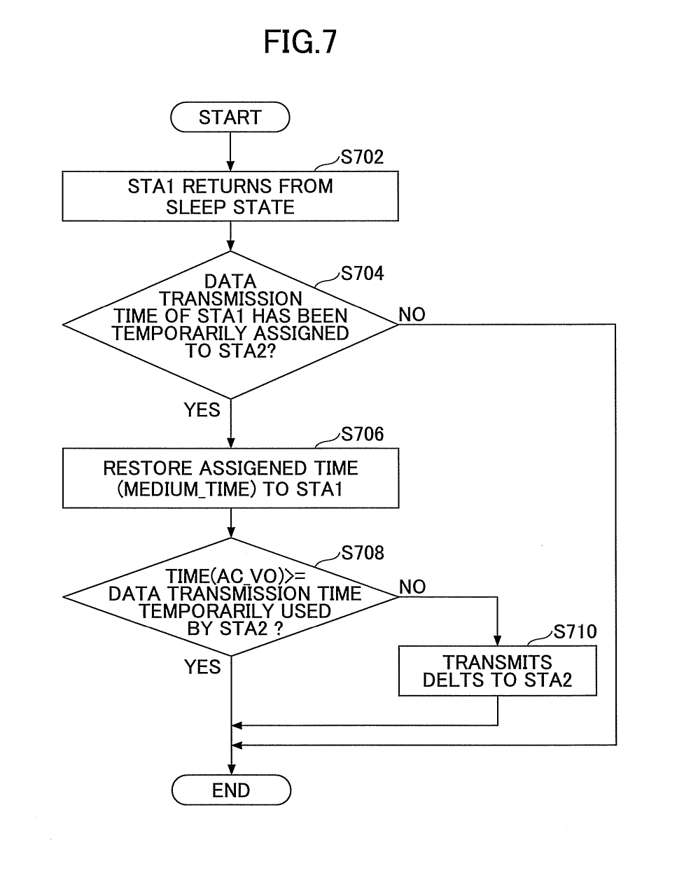

FIG. 7 is a flowchart (2) showing an example of operation of the radio network.

The radio communication apparatus (STA1) 200₁ returns to the normal operation state from the sleep state in step S702.

The AP 100 determines whether the data transmission time assigned to the radio communication apparatus (STA1) 200₁ that returns to the normal state is temporarily assigned to another radio communication apparatus (STA2) 200₂. For example, the scheduling unit 1124 refers to the data transfer time storing unit 1126 and the state management unit 1128 in order to determine whether the data transmission time assigned to the radio communication apparatus (STA1) 200₁ that returns to the normal state is temporarily assigned to another radio communication apparatus (STA2) 200₂.

When it is determined that the data transmission time assigned to the radio communication apparatus (STA1) 200₁ that returns to the normal state is temporarily assigned to another radio communication apparatus (STA2) 200₂ (Yes in step S704), the AP 100 restores (reassigns), to the radio communication apparatus (STA1) 200₁, the data transmission time temporarily assigned to the radio communication apparatus (STA2) 200₂ in step S706. For example, the scheduling unit 1124 restores the data transmission time temporarily assigned to the radio communication apparatus (STA2) 200₂ to the radio communication apparatus (STA1) 200₁.

In step S708, the AP 100 determines whether the total time for data transmission belonging to AC_VO is equal to or longer than the data transmission time temporarily used by the radio communication apparatus (STA2) 200₂. For example, the AP 100 determines whether the equation (5) holds true. For example, the scheduling unit 1124 determines whether the time for data transmission belonging to AC_VO is equal to or longer than the data transmission time temporarily used by the radio communication apparatus (STA2) 200₂.

MEDIUM_TIME(STA2)≦TOTAL_TIME(AC_VO) (5)

In the equation (5), TOTAL_TIME(AC_VO) indicates a total time in which data transmission belonging to AC_VO is currently available, and MEDIUM_TIME(STA2) indicates the data transmission time temporarily assigned to the STA2.

When it is determined that the time for data transmission belonging to AC_VO is equal to or longer than the data transmission time temporarily used by the radio communication apparatus (STA2) 200₂ in step S708 (Yes in step S708), the AP 100 assigns the data transmission available time to the radio communication apparatus (STA2) 200₂. For example, the scheduling unit 1124 assigns the data transmission available time to the radio communication apparatus (STA2) 200₂.

The AP 100 transmits an ADDTS-RESP frame to the STA2 for notification.

On the other hand, when it is determined that the time for data transmission belonging to AC_VO is less than the data transmission time temporarily used by the radio communication apparatus (STA2) 200₂ in step S708 (No in step S708), the AP 100 transmits a DELTS frame to the radio communication apparatus (STA2) 200₂ so as to cause the radio communication apparatus (STA2) 200₂ to stop communication using the access category in step S710. For example, the scheduling unit 1124 causes the radio communication apparatus (STA2) 200₂ to stop communication using the access category.

The processing of steps S704-S710 is executed by the processor 116 according to the function of the scheduler 112. A program for causing the processor 116 to function as the scheduler 112 can be stored in a non-transitory recording medium such as a flexible disk, a CD-ROM and a memory card, a flash ROM and the like, and the non-transitory recording medium in which the program is stored can be provided. Also, the program can be downloaded via a communication network. For example, by inserting the recording medium into an auxiliary storage device of a computer, the program recorded in the recording medium is read. The access point 100 is an example of the computer. The processor 116 writes the read program in the RAM 118 or an HDD, and executes the program to perform the processing. The program causes the computer to execute each step of S704-S710 shown in FIG. 7. Also, for example, the program may be configured to cause the computer to execute at least a part of the steps of S704-S710.

According to the present embodiment, in the radio network using admission control, when a radio communication apparatus that is assigned a radio resource for an access category is in a sleep state, the radio resource assigned to the radio communication apparatus can be temporarily assigned to another radio communication apparatus during the radio communication apparatus is in the sleep state.

According to the present embodiment, since a radio resource assigned to a radio communication apparatus in a sleep state can be assigned to another radio communication apparatus. Thus, radio resources can be used efficiently and at a maximum. Therefore, use efficiency of radio resources can be improved.

According to the present embodiment, there is provided an access point for assigning a radio resource to a radio communication apparatus based on admission control, the access point including:
a state determination unit configured to determine whether there is a first radio communication apparatus that is in a sleep state by a power saving function; and
an assignment unit configured to temporarily assign a radio resource assigned to the first radio communication apparatus to a second radio communication apparatus when the state determination unit determines that there is the first radio communication apparatus.

In the access point, when the first radio communication apparatus returns to a normal operation state, the assignment unit reassigns the radio resource, to the first radio communication apparatus, that is temporarily assigned to the second radio communication apparatus.

The access point may further includes:
a radio resource determination unit configured to determine whether there is enough radio resource to be assigned to the second radio communication apparatus after the radio resource temporarily assigned to the second radio communication apparatus is reassigned to the first radio communication apparatus; and
a notification unit configured to notify the second radio communication apparatus to stop use of the radio resource when the radio resource determination unit determines that there is not enough radio resource to be assigned to the second radio communication apparatus.

In the access point, when the second radio communication apparatus requests data transmission of a first category for which there is not enough idle radio resource, the state determination unit determines whether there is a third radio communication apparatus that is assigned a radio resource usable in a second access category other than the first access category and that is in the sleep state by the power saving function, and
when the state determination unit determines that there is the third radio communication apparatus, the assignment unit assigns the radio resource, to the second radio communication apparatus, that is temporarily assigned to the third communication apparatus.

According to the present embodiment, there is provided a communication control method in an access point for assigning a radio resource to a radio communication apparatus based on admission control, the communication control method comprising the steps of:
determining whether there is a first radio communication apparatus that is in a sleep state by a power saving function; and
temporarily assigning a radio resource assigned to the first radio communication apparatus to a second radio communication apparatus when it is determined that there is the first radio communication apparatus.

The communication control method may include a step of reassigning the radio resource, to the first radio communication apparatus, that is temporarily assigned to the second radio communication apparatus when the first radio communication apparatus returns to a normal operation state.

The communication control method may further include the steps of:
determining whether there is enough radio resource to be assigned to the second radio communication apparatus after the radio resource temporarily assigned to the second radio communication apparatus is reassigned to the first radio communication apparatus; and
notifying the second radio communication apparatus to stop use of the radio resource when it is determined that there is not enough radio resource to be assigned to the second radio communication apparatus.

In the communication control method, when the second radio communication apparatus requests data transmission of a first category for which there is not enough idle radio resource, the access point determines whether there is a third radio communication apparatus that is assigned a radio resource usable in a second access category other than the first access category and that is in the sleep state by the power saving function, and
when it is determined that there is the third radio communication apparatus, the access point assigns the radio resource, to the second radio communication apparatus, that is temporarily assigned to the third communication apparatus.

According to the present embodiment, there is provided a non-transitory computer-readable recording medium storing a program for causing a computer functioning as an access point to execute the steps of:
determining whether there is a first radio communication apparatus that is in a sleep state by a power saving function; and
temporarily assigning a radio resource assigned to the first radio communication apparatus to a second radio communication apparatus when it is determined that there is the first radio communication apparatus.

Although the present invention has been described with reference to the specific embodiments, the embodiments are simply illustrative, and various variations, modifications, alterations and replacements could be appreciated by those skilled in the art. For convenience, apparatuses according to the embodiments of the present invention have been described by using functional block diagrams, but the apparatuses may be implemented in hardware, software or combinations thereof. The present invention is not limited to the above embodiments, and various variations, modifications, alterations and replacements can be included in the present invention without deviating from the sprit of the present invention.

What is claimed is:

1. An access point for assigning a radio resource to a radio communication apparatus based on admission control, the access point comprising:
a state determination unit configured to determine whether there is a first radio communication apparatus that is in a sleep state by a power saving function; and
an assignment unit configured to temporarily assign a radio resource assigned to the first radio communication apparatus to a second radio communication apparatus when the state determination unit determines that there is the first radio communication apparatus.

2. The access point as claimed in claim 1, wherein, when the first radio communication apparatus returns to a normal operation state, the assignment unit reassigns the radio resource, to the first radio communication apparatus, that is temporarily assigned to the second radio communication apparatus.

3. The access point as claimed in claim 2, further comprising:
a radio resource determination unit configured to determine whether there is enough radio resource to be assigned to the second radio communication apparatus after the radio resource temporarily assigned to the second radio communication apparatus is reassigned to the first radio communication apparatus; and
a notification unit configured to notify the second radio communication apparatus to stop use of the radio resource when the radio resource determination unit determines that there is not enough radio resource to be assigned to the second radio communication apparatus.

4. The access point as claimed in claim 1, wherein, when the second radio communication apparatus requests data transmission of a first category for which there is not enough idle radio resource, the state determination unit determines whether there is a third radio communication apparatus that is assigned a radio resource usable in a second access category other than the first access category and that is in the sleep state by the power saving function, and
when the state determination unit determines that there is the third radio communication apparatus, the assignment unit assigns the radio resource, to the second radio communication apparatus, that is temporarily assigned to the third communication apparatus.

5. A communication control method in an access point for assigning a radio resource to a radio communication apparatus based on admission control, the communication control method comprising the steps of:
determining whether there is a first radio communication apparatus that is in a sleep state by a power saving function; and
temporarily assigning a radio resource assigned to the first radio communication apparatus to a second radio communication apparatus when it is determined that there is the first radio communication apparatus.

6. The communication control method as claimed in claim 5, comprising a step of reassigning the radio resource, to the first radio communication apparatus, that is temporarily assigned to the second radio communication apparatus when the first radio communication apparatus returns to a normal operation state.

7. The communication control method as claimed in claim 6, further comprising the steps of:
determining whether there is enough radio resource to be assigned to the second radio communication apparatus after the radio resource temporarily assigned to the second radio communication apparatus is reassigned to the first radio communication apparatus; and
notifying the second radio communication apparatus to stop use of the radio resource when it is determined that there is not enough radio resource to be assigned to the second radio communication apparatus.

8. The communication control method as claimed in claim 6, wherein, when the second radio communication apparatus requests data transmission of a first category for which there is not enough idle radio resource, the access point determines whether there is a third radio communication apparatus that is assigned a radio resource usable in a second access category other than the first access category and that is in the sleep state by the power saving function, and
when it is determined that there is the third radio communication apparatus, the access point assigns the radio resource, to the second radio communication apparatus, that is temporarily assigned to the third communication apparatus.

9. A non-transitory computer-readable recording medium storing a program for causing a computer functioning as an access point to execute the steps of:
determining whether there is a first radio communication apparatus that is in a sleep state by a power saving function; and
temporarily assigning a radio resource assigned to the first radio communication apparatus to a second radio communication apparatus when it is determined that there is the first radio communication apparatus.
